(19) United States
(12) Patent Application Publication
(10) Pub. No.: US 2015/0362831 A1
(43) Pub. Date: Dec. 17, 2015

(54) LASER PROJECTION DEVICE

(71) Applicant: HON HAI PRECISION INDUSTRY CO., LTD., New Taipei (TW)

(72) Inventor: KAI-WEN WU, New Taipei (TW)

(21) Appl. No.: 13/921,219

(22) Filed: Jun. 19, 2013

(30) Foreign Application Priority Data
Apr. 24, 2013 (TW) 102114712

(51) Int. Cl. G03B 21/20; G01J 3/12

(52) U.S. Cl. CPC G03B 21/2033; G01J 3/12; G03B 21/2013; G03B 21/2066

(57) ABSTRACT

An exemplary laser projection device includes a substrate, a first laser diode, a second laser diode, a third laser diode, and a triangular spectroscope located among the first, second and third laser diodes. The first, second and third laser diodes are located at vertices of a triangle, respectively. The spectroscope is located on light paths of the laser diodes. The spectroscope includes a first lateral face, a second lateral face, and a third lateral face interconnecting the first lateral face and the second lateral face. Each lateral face of the spectroscope is corresponding with one respective laser diode. A first and a second light splitting films are formed on two of the lateral faces of the spectroscope respectively. Light emitted from the laser diodes is adjusted by the first and second light splitting films to transmit along a common direction and be mixed with each other.

### BACKGROUND

1. Technical Field

The disclosure generally relates to laser projection devices and more particularly to a laser projection device which uses a triangular spectroscope to combine and mix laser beams from different laser sources to form a white laser beam.

2. Description of Related Art

Laser projection devices are more and more popular for their projected images having a lager color gamut, a higher brightness, an increased contrast and a better saturation of color.

A typical laser projection device 100a includes a substrate 10a, a plurality of laser diodes 21a, 23a, 25a mounted on a top surface of the substrate 10a, and a plurality of beam splitters 31a, 33a, 35a located on light paths of the laser diodes 21a, 23a, 25a respectively. The laser diodes 21a, 23a, 25a are spaced from each other, and are arranged in a line along a longitudinal direction of the substrate 10a. The beam splitters 31a, 33a, 35a are spaced from each other, and are arranged in a line along a longitudinal direction of the substrate 10a. Each beam splitter 31a (33a, 35a) is aligned with one respective laser diode 21a (23a, 25a). Light emitted from the laser diodes 21a, 23a, 25aradiates to the beam splitters 31a, 33a, 35a, and then is adjusted by the beam splitters 31a 33a, 35a to be oriented toward a same direction and mixed together.

However, the arrangement and distribution of the laser diodes 21a, 23a, 25a and the beam splitters 31a, 33a, 35a in FIG. 1 require the substrate 10a to have a large size, which results in that the laser projection device 100a has an increased bulk.

What is needed, therefore, is an improved laser projection device which can overcome the described-above shortcomings.

### BRIEF DESCRIPTION OF THE DRAWINGS

FIG. 1 is a schematic view showing a conventional laser projection device.

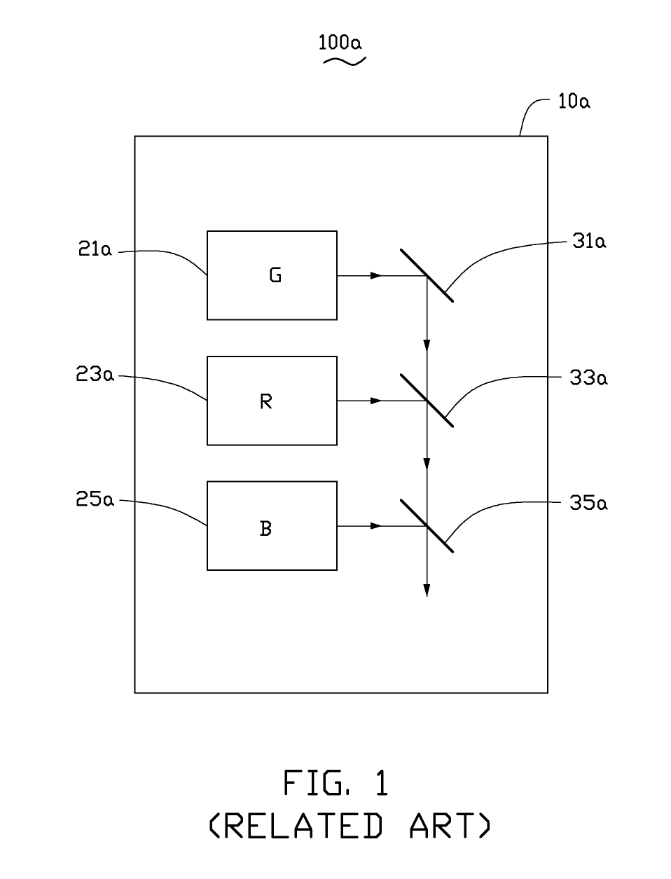

FIG. 2 is a schematic view showing a laser projection device according to an exemplary embodiment of the present disclosure.

FIG. 3 is a schematic view showing light paths of the laser projection device of FIG. 2.

### DETAILED DESCRIPTION

Embodiment of laser projection device will now be described in detail below and with reference to the drawings.

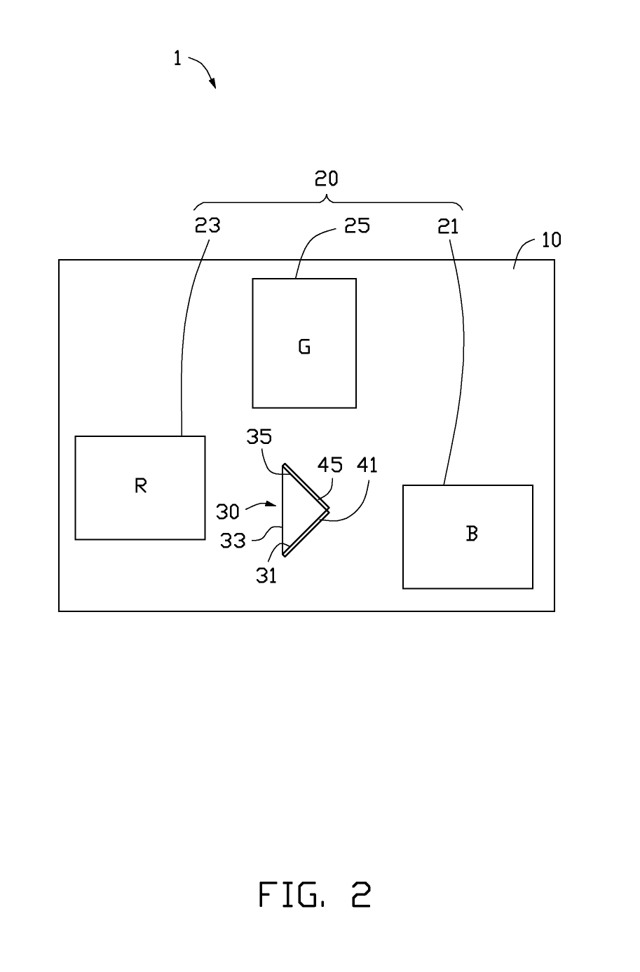

Referring to FIG. 2, a laser projection device 1 according to an exemplary embodiment of the present disclosure includes a substrate 10, a laser light source 20, and a spectroscope 30. The laser light source 20 and the spectroscope 30 are mounted on the substrate 10. The spectroscope 30 is arranged on light paths of light emitted from the light source 20.

The substrate 10 is flat. The laser light source 20 and the spectroscope 30 are arranged on a top surface of the substrate 10. A circuit (not shown) is arranged on the top surface of the substrate 10. In this embodiment, the substrate 10 is made of electrically insulating material, such as silicone or epoxy.

The laser light source 20 includes a first laser diode 21, a second laser diode 23 and a third laser diode 25. And the first, second and third laser diodes 21, 23, 25 are spaced from each other, generally located at the vertices of a triangle, respectively. The spectroscope 30 is located among the first, second and third laser diodes 21, 23, 25. Each of the laser diodes 21, 23, 25 is electrically connected to the circuit. A brightness of light generated by each laser diode 21 (23, 25) can be controlled by adjusting a current flowing through the respective laser diode via the circuit. The laser diodes 21, 23, 25 are used to emit laser beams with different colors needed.

The spectroscope 30 is a triangular prism, and the spectroscope 30 includes a first lateral face 31, a second lateral face 33 and a third lateral face 35 connecting the first and second lateral faces 31, 33. Each lateral face 31(33, 35) is generally oriented facing a corresponding laser diode 21(23, 25). In detail, the first lateral face 31 is oriented facing the first laser diode 21, the second lateral face 33 is oriented facing the second laser diode 23, and the third lateral face 35 is oriented facing the third laser diode 25.

A first light splitting film 41 is formed on the first lateral face 31, and a second light splitting film 45 is formed on the third lateral face 35. A size of the first light splitting film 41 equals the size of the first lateral face 31 of the spectroscope 30, and a size of the second light splitting film 45 equals the size of the third lateral face 35. A thickness of the first light splitting film 41 equals a thickness of the second light splitting film 45. Light emitted from the laser diodes 21, 23, 25 can be adjusted by the first and second light splitting films 41, 45 to transmit along a common direction to be mixed with each other.

In this embodiment, the first laser diode 21 is a blue laser diode, the second laser diode 23 is a red laser diode, and the third laser diode 25 is a green laser diode. The first light splitting film 41 is a blue light splitting film, and the second light splitting film 45 is a red light splitting film. The blue light splitting film 41 may reflect the blue light from the first laser diode 21, but allows light of other colors (i.e., not blue) to pass through; and the red light splitting film 45 may reflect the red light from the third laser diode 23, but allows light of other colors (i.e., not red) to pass through.

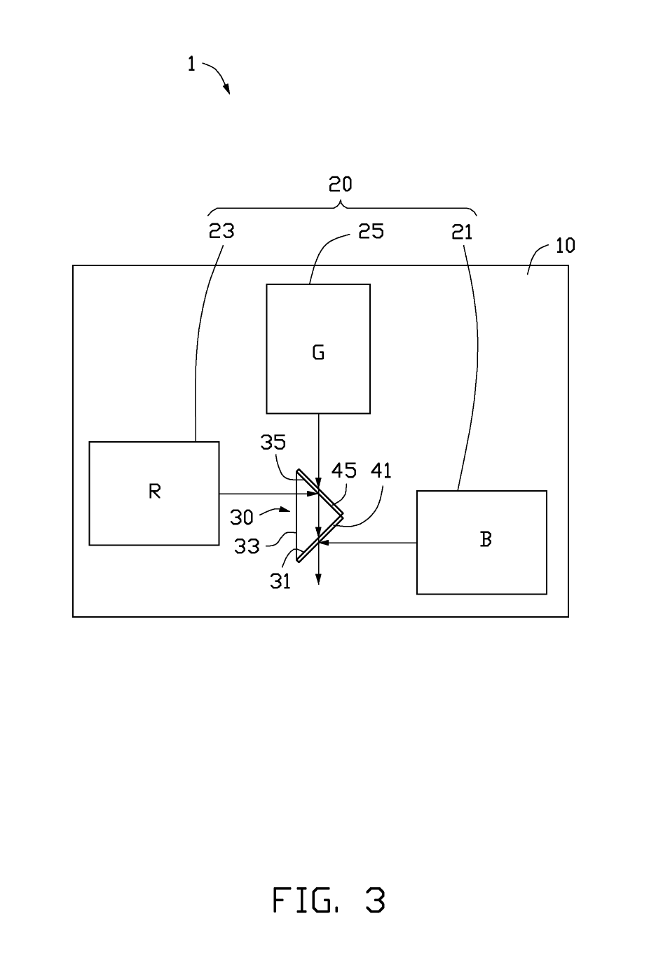

Referring to FIG. 3, when the laser projection device 1 works, the blue laser beams emitted into the first light splitting film 41 from the first laser diode 21 are reflected by the first light splitting film 41 to emit out from a bottom side of the substrate 10; the red laser beams emitted from the second laser diode 23 emit into the second light splitting film 45 from the second lateral face 33, and then are reflected by the second light splitting film 45 to pass through the first lateral face 31 and the first light splitting film 41 to emit out in a same direction with the blue laser beams; the green laser beams emitted from the third laser diode 25 pass through the second light splitting film 45, the third and first lateral faces 35, 31 of the spectroscope 30 and the first light splitting film 41 sequentially to be mixed with the blue laser beams and red laser beams in a common direction to obtain resultant light of a predetermined color which is white. An upward extension of the resultant light passes through the first and second light spitting films 41, 45.

According to the laser projection device 1 of the present disclosure, because the first and second light splitting films 41, 45 are formed on the first and third lateral faces 31, 35 of one spectroscope 30 which is a triangle prism and the laser diodes are located at vertices of a triangle, an area of the substrate 10 occupied by the laser diodes and the light splitting films is reduced, whereby an area of the substrate 10 can be reduced and the bulk of the laser projection device 1 can also be reduced.

It is to be further understood that even though numerous characteristics and advantages of the present embodiment have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A laser projection device comprising:
a substrate;
a first laser diode, a second laser diode and a third laser diode mounted on the substrate, located at vertices of a triangle, respectively; and
a spectroscope located among the first, second and third laser diodes and on laser beams paths of the laser diodes, the spectroscope being triangular in shape and comprising a first lateral face, a second lateral face and a third lateral face connecting the first and second lateral faces, the first lateral face of the spectroscope being located corresponding with the first laser diode, the second lateral face of the spectroscope being located corresponding with the second laser diode, the third lateral face of the spectroscope being located corresponding with the third laser diode, a first light splitting film and a second light splitting film being formed on two of the lateral faces of the spectroscope, light emitted from the laser diodes being adjusted by the first and second light splitting films to a common direction to be mixed together as a resultant light, an extension of the resultant light passing through the first and second light splitting films.

2. The laser projection of claim 1, wherein the spectroscope is a triangular prism.

3. The laser projection of claim 1, wherein the first laser diode is a blue laser diode, the second laser diode is a red laser diode, and the third laser diode is a green laser diode.

4. The laser projection of claim 3, wherein the first light splitting film is a blue light splitting film formed on the first lateral face of the spectroscope, and the second light splitting film is a red light splitting film formed on the third lateral face of the spectroscope.

5. The laser projection of claim 4, wherein a size of the first light splitting film equals the first lateral face of the spectroscope, and a size of the second light splitting film equals the third lateral face of the spectroscope.

6. The laser projection of claim 5, wherein a thickness of the first light splitting film equals a thickness of the second light splitting film.

7. The laser projection of claim 6, wherein blue laser beams emitted into the first light splitting film from the first laser diode are reflected by the first light splitting film to emit out from a side of the substrate, red laser beams emitted from the second laser diode emit into the second light splitting film from the second lateral face, and then the red laser beams are reflected by the second light splitting film to pass through the fist lateral face and the first light splitting film to emit out in a same direction with the blue laser beams, green laser beams emitted from the third laser diode pass through the second light splitting film, the spectroscope and the first light splitting film sequentially to be mixed with the blue laser beams and red laser beams in a common direction to obtain the resultant light which is white in color.
